(19) United States
(12) Patent Application Publication
(10) Pub. No.: US 2009/0217388 A1
(43) Pub. Date: Aug. 27, 2009

(54) Apparatus for and a method of copy-protecting a content carrying recording medium

(75) Inventor: Carmen Laura Basile, Maidenhead (GB)

Correspondence Address: PATENT DEPARTMENT;MACROVISION CORPORATION, 2830 DE LA CRUZ BLVD., SANTA CLARA, CA, 95050, US

(73) Assignee: Macrovision Corporation, Santa Clara, CA (US)

(21) Appl. No.: 12/072,821

(22) Filed: Feb. 27, 2008

(51) Int. Cl. G06F 21/00

(52) U.S. Cl. 726/32

(57) ABSTRACT

Recording data to be recorded on an optical disc such as a DVD has at least one video title set having content data files having a video object data set, a video title set information file for the video title set and video manager information. The recording data also has a volume file system information having data relating to file identification for enabling location of content data files. In order to inhibit copying by a file-by-file copying apparatus data relating to file identification in the volume information for at least one of the content data files is caused to be incorrect, for example altered The incorrect information may be at least one of a file start address, a file length, incorrect error detection data, a pointer to a corrupt video title set information file rather than the correct video title set information file.

### FIELD OF THE INVENTION

This invention relates to an apparatus for and a method of copy-protecting a content carrying recording medium against unauthorised copying of that content where the recording medium is an optical disc (or a precursor thereof) or other recording medium from which content data that can be accessed in a non-sequential manner using navigational data stored by the recording medium, to a recording medium having such copy protection and to copy-protected data for recordal on a recording medium. For simplicity, a recording medium from which content data that can be accessed in a non-sequential manner using navigational data stored by the recording medium is referred to hereinafter simply as a “recording medium”.

### BACKGROUND OF THE INVENTION

The advent of digital recording techniques has enabled digital copies of digital content carried by recording media such as optical discs (for example DVDs) to be made with little or no loss of copy quality. This makes it easy for an unauthorised person to produce unauthorised copies of digital content-carrying recording media. Accordingly, copy-protection techniques have been developed. Most current copy-protection techniques exploit differences in the ways a legitimate player and an unauthorised copying apparatus or “ripper” would access a recording medium in order to defeat copying while preserving good playability. As an example, a legitimate DVD player follows a navigational path on the DVD that is defined by navigational commands and control data carried by the DVD whereas most unauthorised copying apparatus or rippers access the content of a DVD file-by-file or sector-by-sector. Accordingly, production of good quality or playable copies by a file-by-file or sector-by-sector unauthorised copying apparatus can be frustrated by adding subversive data (that is data that detrimentally affects at least one of the copying process, copy quality and playability of a copy) to a part of the digital data that does not form part of the navigational path of the DVD so that the subversive data is ignored by a legitimate player but detrimentally affects the production of an unauthorised copy. For example, data may be altered to affect the digital sum value (DSV) of some of the digital data in a manner which does not affect a legitimate player but interferes with an unauthorised copying apparatus or “ripper”.

The above types of copy-protection may prevent digital copying of the content of an optical disc such as a DVD by a ripper that copies the data on a sector-by-sector or a file-by-file basis. However, other more sophisticated rippers may be able to parse navigation information contained on the optical disc so as to select the content data be copied. Thus, for example, so-called “IFO parsing rippers” are capable of parsing navigation information contained on a DVD and automatically selecting the “main title” or the “main program chain (PGC)” for ripping or allowing the user the possibility of selecting a particular title or a particular program chain from amongst those available.

### SUMMARY OF THE INVENTION

An embodiment provides apparatus for providing, for recordal onto a recording medium, recording data having content data and control data for enabling a player playing such a recording medium to navigate through the content data. In an embodiment, the recording data has content data comprising a plurality of content data files and navigation data to enable a player of the recording medium to navigate through the content data, the recording data also having volume information comprising location data representing the location of the content data files within the recording volume, and the apparatus is operable to cause at least some data relating to file identification information in the volume information for at least one of the content data files to be incorrect, for example to alter the data, to inhibit a reader reading the volume information from finding the file or files.

An embodiment apparatus for providing recording data to be recorded onto a recording medium, the apparatus comprising a data processor operable:

to provide recording data comprising at least one video title set having content data files comprising a video object data set, a video title set information file for the video title set and video manager information and comprising a volume file system information having identification information for enabling location of content data files; and

to cause at least some data relating to identification information in the volume file system information for at least one of the content data files to be incorrect to inhibit a reader reading the volume file system information from finding the file or files.

The identification information may comprise a file start address and a file length for each content data file and the data processor may be operable to alter at least one of the file length and the file start address for at least one of the content data files. As another possibility error data may be incorrect, for example the Cyclic Redundancy Check may be altered or corrupted.

The data processor may alternatively or additionally be operable to add a corrupt video title set information file or a content data file to the recording data for at least one video title set and the identification information may comprise information identifying the corrupt video title set information file or content data file rather than the actual video title set information file or content data file for the at least one video title set.

The volume information may comprise at least one of UDF and ISO information.

In an embodiment, recording data to be recorded on an optical disc such as a DVD has at least one video title set having content data files having a video object data set, a video title set information file for the video title set and video manager information. The recording data also has volume file system information having identification information for enabling location of content data files. In order to inhibit copying by a file-by-file or an IFO parsing copying apparatus identification information in the volume information for at least one of the content data files is caused be incorrect, for example altered. The incorrect information may be a file start address or length or may point to a corrupt video title set information file rather than the correct video title set information file or may be in the error detection data (for example the CRC may be altered or corrupted). In an embodiment, recording data to be recorded on an optical disc such as a DVD has at least one video title set having content data files having a video object data set, a video title set information file for the video title set and video manager information. The recording data also has a volume file system information having data relating to file identification for enabling location of content data files. In order to inhibit copying by a file-by-file copying apparatus data relating to file identification in the volume information for at least one of the content data files is caused to be incorrect, for example altered. The incorrect information may be at least one of a file start address, a file length, incorrect error detection data, a pointer to a corrupt video title set information file rather than the correct video title set information file.

The present invention also provides a method of causing identification information in the volume information for at least one of the content data files to be incorrect to inhibit a reader reading the volume information from finding the file or files.

The method may further comprise at least one of: providing a recording data file comprising the recording data; producing a master carrying the recording data; producing a precursor to a master carrying the recording data; producing at least one recorded medium such as an optical disc, for example a DVD carrying the recording data; and writing the recording data onto a writable or rewritable optical disc, for example a DVD. The invention also provides the recording data itself and a recording medium carrying the recording data. The present invention also provides a computer-readable medium storing computer-readable instructions to program a processor to carry out the method.

The recording medium may be an optical disc such as a DVD or a precursor thereof such as Digital Linear Tape, glass master, or stamping master, or may be any other form of recording medium from which content data that can be accessed in a non-sequential manner using navigational data stored by the recording medium.

### BRIEF DESCRIPTION OF THE DRAWINGS

Embodiments of the present invention will now be described, by way of example, with reference to the accompanying drawings, in which:

FIG. 1 shows a functional block diagram of producing apparatus for producing a copy-protected optical disc such as a DVD;

FIG. 2 shows a functional block diagram of reading apparatus for reading a copy-protected optical disc such as a DVD;

FIG. 3 shows a functional block diagram of computing apparatus that may be programmed to provide the copying apparatus shown in FIG. 1;

FIG. 4 shows a diagram illustrating an example of computing apparatus having the functionality shown in FIG. 3;

FIG. 5 shows a diagram for explaining the navigational and presentation data structure of an example of a DVD Video protected according to one embodiment of the present invention;

FIG. 6 shows a diagram for explaining the physical data structure of a DVD-Video;

FIG. 7 shows a video manager information (VMGI) table of a DVD;

FIGS. 8a to 8d show a video title set information (VTSI) table of a DVD;

FIG. 9 shows a UDF/ISO file system information table of a DVD;

FIGS. 10 and 11 show diagrams for illustrating pointers to files from the UDF/ISO file system information and from the VMGI and VTSI;

FIGS. 12 and 13 show a flow chart and a diagram, respectively, for explaining operations carried out by the apparatus shown in FIG. 1;

FIG. 14 shows a flow chart for illustrating operations carried out in a method in accordance with the invention to provide copy protection;

FIG. 15 shows a modified version of FIG. 10 to illustrate the effects of the method illustrated by FIG. 14;

FIG. 16 shows a flow chart for illustrating operations carried out in another method in accordance with the invention to provide copy protection; and

FIG. 17 shows a diagram for illustrating the effects of the method illustrated by FIG. 16.

### DETAILED DESCRIPTION OF EMBODIMENTS

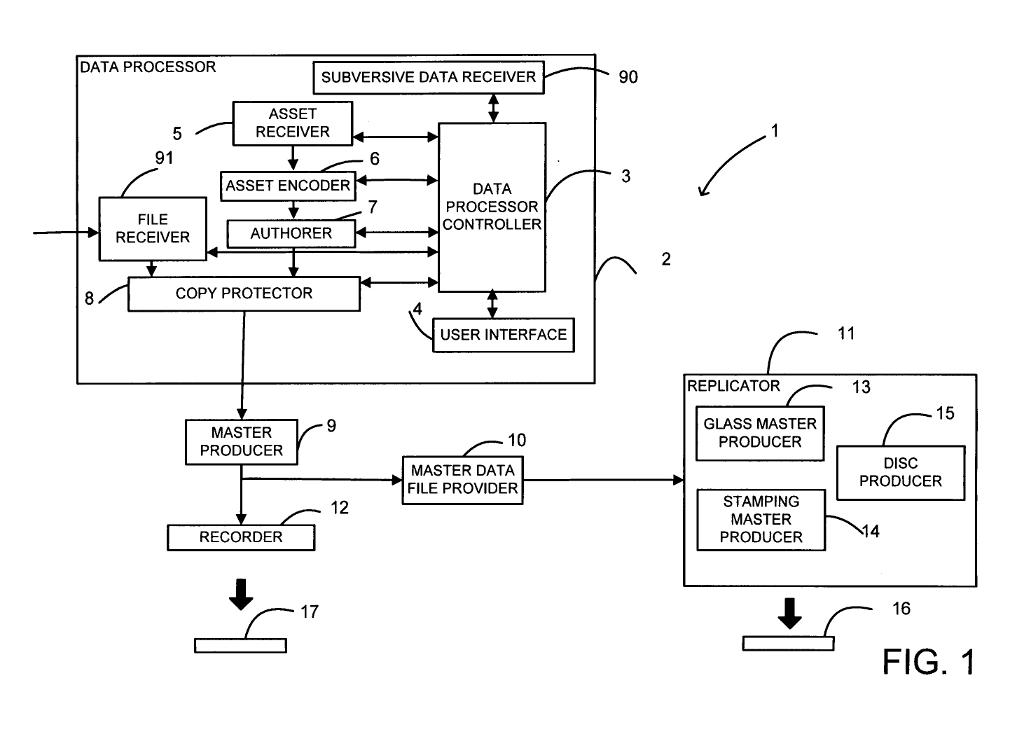

Referring now to FIG. 1, a producing apparatus 1 has a data processor 2 operable, under user control, to provide recording data to be recorded onto an optical disc, in this case a Digital Versatile Video Disc (DVD-Video, abbreviated to DVD herein), which recording data is copy-protected by causing file identification information in the volume information (at least one of the UDF and ISO information for a DVD for example) for recording data to be incorrect for at least one of the content data files of the recording data (for example by altering the information or adding corrupt information files to inhibit a file-by-file reader reading or copying the content data), whilst still allowing a file-by-file player or a navigation-based player to play the disc.

The data processor 2 has a data processor controller 3 to control overall operation of the data processor 2, a user interface 4 operable to provide a user with information and to receive instructions from the user, an asset receiver 5 operable to receive assets (such as the video data file or data files plus any additional audio data files and graphics data files for logos, menus and the like) selected by the user to form the content of the DVD and an asset encoder 6, operable, under the control of the controller 3 and in accordance with user instructions received via the user interface 4, to effect any required encoding of the assets to ensure that the assets are in a format specified by the DVD standard with which the DVD is to comply, for example MPEG 2 for video data.

The data processor also has an authorer 7 that enables the user, via the user interface 4, to specify parameters of the DVD being produced such as the video format and disc size, to import encoded assets from the asset encoder 6, to synchronise assets, and to add chapter points, create menus and so on to ensure that the final DVD has the required presentation data (that is the audio and video content data to be delivered to a viewer by a DVD player) and navigation data (comprising general control data, search control data, user interface control data and navigation control data) to enable navigation through the content of the DVD in a non-sequential manner in accordance with the appropriate DVD standard. The authorer 7 thus, under user control, multiplexes the assets, adds navigation and control information according to the appropriate DVD standard specification and writes out an authored data file or final disc image or DDP (Disc Description Protocol) File Set containing the appropriate DVD specification data files in a directory. The authorer 7 is generally also able to simulate the resulting DVD so that the user can review and check their work.

The data processor 2 may also have a file receiver 91 to receive already authored DVD-Video content in the form of DVD-Video files, or as an image file or as a DDP File Set.

The data processor 2 may also include a subversive data receiver 90 operable to receive subversive data.

The data processor 2 also has a copy protector 8 to provide copy protection to a DVD-Video file, an image file or a DDP File Set provided by the authorer 7 or by the file receiver 91, as will be described below. Where authoring is to be carried out by the authorer 7, the functionality provided by the copy protector 8 may form part of the authorer so that the copy protection can be effected during the authoring process that results in the DDP File Set.

The data processor 2 is coupled to provide the copy-protected file to a master producer 9 configured to carry out a conventional mastering process including encoding the copy-protected image file or DPP File Set in accordance with the appropriate DVD standard specification to produce channel code data for recording, that is to carry out processes such as scrambling, interleaving, error correction and EFM plus encoding in accordance with the appropriate DVD standard specification.

The master producer 9 is arranged to provide the resulting master file to at least one of a local recorder 12 and a master data file provider 10 which in known manner provides a data file, for example a digital linear tape (DLT) file, for supply to a replicator 11. The replicator 11 will normally, although not necessarily, be located remotely of the remainder of the producing apparatus and will generally have a glass master producer 13 to cut a glass master, a stamping master producer 14 to produce stamping masters from the glass master and a disc producer 15 to produce the final DVD discs 16 from the stamping masters. Any local recorder 12 will be in the form of a DVD writer that writes or records on writable or rewritable DVD discs to produce one or more recorded discs 17. The master producer 9 is shown as a separate component but may be part of the data processor 2 or its functionality may possibly be provided by the recorder 12 and/or master data file provider 10.

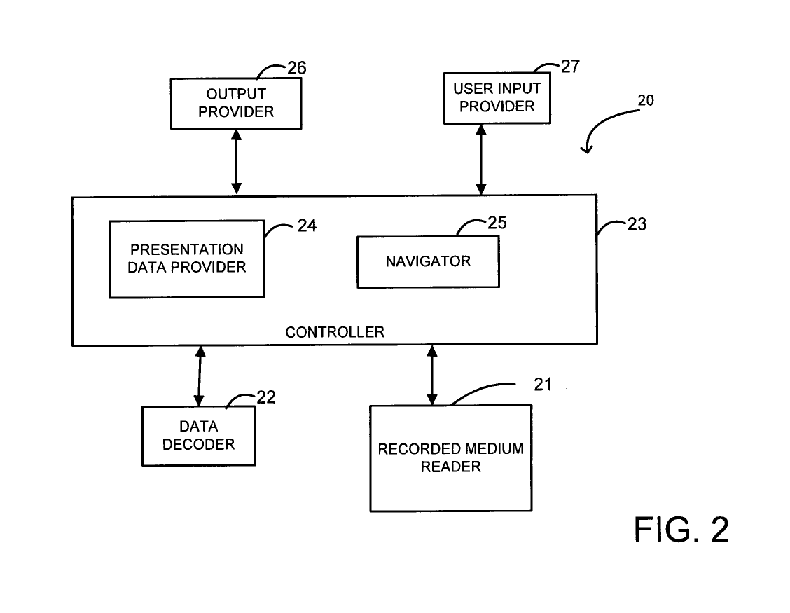

FIG. 2 shows a block diagram of a player 20 suitable for playing a copy-protected DVD produced by the apparatus shown in FIG. 1. The player 20 may be a dedicated DVD player or could be a personal or other computer having DVD playing capability. The player 20 has a recorded medium reader 21 with read head circuitry operable to read sectors of data from a recorded DVD and a data decoder 22 operable to decode channel data read by the read head circuitry. Although not shown in FIG. 2, the data decoder 22 may where appropriate have a clock extractor for extracting a clock signal, a de-interleaver or de-shuffler for de-shuffling sectors and a channel decoder for decoding the channel data.

The player 20 has a controller 23 which controls overall operation of the reading apparatus and which includes a presentation data provider 24 to provide presentation data to an output provider 26 which is generally in the form of a display such as a monitor or TV display, but could be a communications link to a display. The controller 23 also provides a navigator 25 to control the location on the DVD that is read by the read head circuitry of the recording medium reader 21 in accordance with user input instructions received via a user input provider 27 (which may be a keyboard, pointing device and/or a remote control, for example) and navigation or control data read from the DVD.

It will of course be appreciated that the functional components shown in FIGS. 1 and 2 simply illustrate the provided functionality and should not be taken to imply that these functional components necessarily exist as discrete physical entities. Rather, the functionality may be provided by one or more physical components and, in the latter case, the functionality provided by a single functional component shown in FIG. 1 or 2 may be distributed between different physical components. In addition, different aspects of the functionality may not be identifiable as separate functionality.

The functional components shown in FIGS. 1 and 2 may, as appropriate, be provided by hardware, firmware, software or any combination of these.

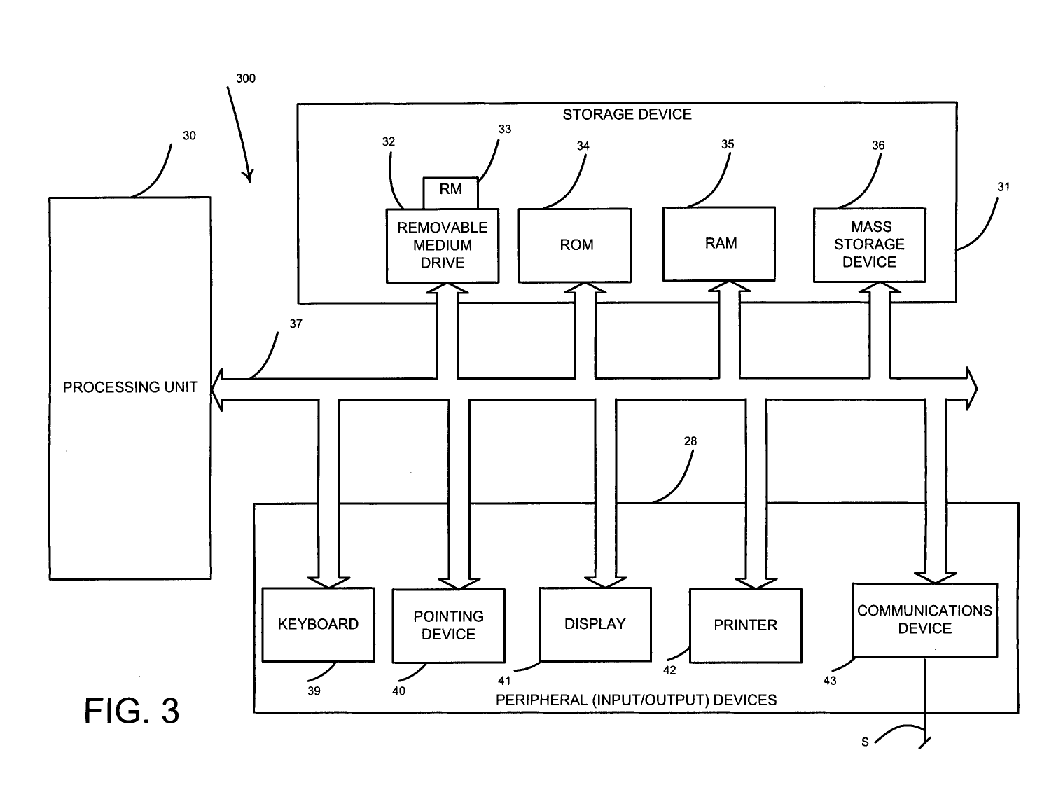

FIG. 3 shows a functional block diagram of computing apparatus 300 that may be programmed by program instructions to provide, for example, at least one of the data processor 1, master producer 9, recorder 12 and master data file provider 10 shown in FIG. 1 and/or the player 20 shown in FIG. 2.

The computing apparatus 300 comprises a processing unit 30 coupled by one or more buses 37 to storage devices 31 which comprise a removable medium drive 32 for receiving a removable medium RM 33 (in this case a DVD drive for receiving a DVD and/or a DLT drive), a read only memory (ROM) 34, a random access memory (RAM) 35 and a mass storage device 36 such as a hard disc drive.

The bus 37 also couples the processing unit 30 to a number of peripheral input/output devices that may form the user interface 20 of FIG. 1 and the output provider 26 and user input provider 27 of FIG. 2, in this case a keyboard 39, a pointing device 40 and a display 41. The peripheral devices may also include a communications device 43 to provide network communication and, optionally, a printer 42. The communications device 43 may be, for example, a MODEM, network card or the like for enabling the computing apparatus 300 to communicate over a network which may be the Internet but could alternatively or additionally be an intranet, a local area network, wide area network or any other suitable form of network.

It will, of course, be appreciated that the storage devices and input/output devices may not comprise all of those shown in FIG. 3 and/or could comprise additional devices. For example, one or more further removable medium drives, such as a floppy disc drive and a Digital Linear Tape (DLT) drive, may be provided and other input/output devices such as a microphone and a loudspeaker may be provided.

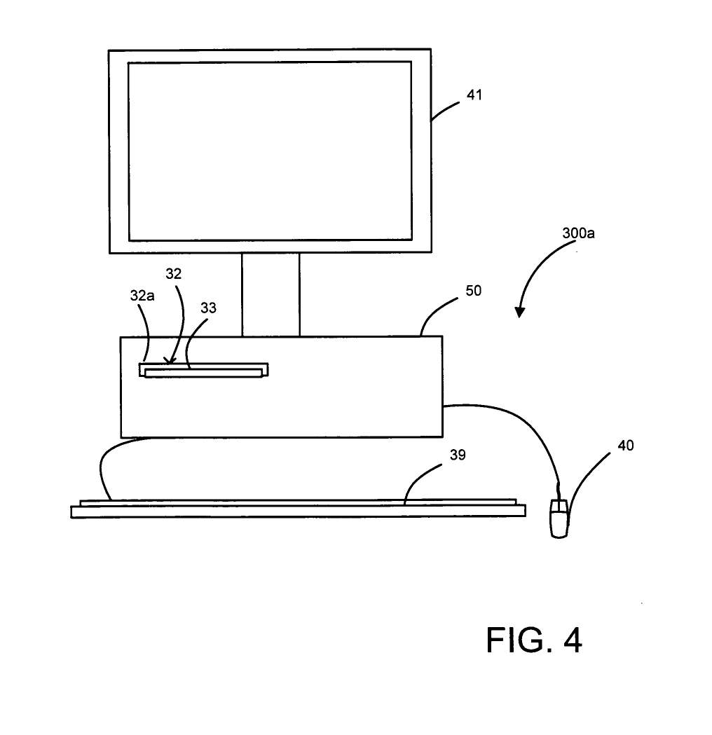

As shown diagrammatically in FIG. 4, the computing apparatus may be a personal computer or server 300a which has a main processor unit 50 containing the processing unit 30 and storage devices 31 and user interface devices in the form, as shown, of a keyboard 39, mouse 40 and display 41. FIG. 3 shows a removable medium 33 being ejected from an insertion slot 32a of the removable medium drive 32.

The computing apparatus 300 or 300a may be programmed to provide the copying apparatus 1 shown in FIG. 1 by program instructions supplied by any one or more of the following routes:
pre-stored in the ROM 34 and/or the mass storage device 36;
input by a user using an input device such as the keyboard 39 and/or the pointing device 40.
downloaded from a removable medium 33 received by the removable medium drive 32; and
supplied as a signal S via the communications device 43.

Of course, where apparatus has different physical components, then these may be provided by programming of corresponding respective computing apparatus.

The apparatus shown in FIG. 1 enables a DVD to be produced that is difficult for a ripper to copy.

To facilitate understanding of how the apparatus 1 shown in FIG. 1 functions, the structure of a DVD first needs to be discussed.

A DVD has a complex and non-linear structure with multiple elementary streams being interleaved and multiple discrete elements of content organized in a structured and hierarchical manner within a DVD video zone. Navigation to and through the digital presentation data stored on a DVD is controlled by navigation data which may be present at different levels in the physical data structure of the DVD video zone. The presentation data of a DVD video zone thus cannot be played simply by the player 20 accessing the recorded data in sequential manner from the beginning to the end of the recording of the data on the DVD. Rather, the navigation path or paths taken through the content by the player 20 depend(s) upon the navigator 25 of the player 20, the way the DVD is authored, and interaction with the user.

A DVD comprises a physical data structure and a logical data structure in the form of a logical hierarchy that overlies the physical data structure. The physical data structure determines the manner in which data is organised on a DVD with, in accordance with the DVD standards, data being stored in a sequential and physically contiguous or sequential manner on the DVD. The logical data structure determines the grouping of video sequences and the play back order of blocks of video in a sequence. The data to be recorded on the disc is organised in physical sectors. Each physical sector consists of a SYNC block, a header, a data pack and error detection code. In order to ensure that channel coding rules are met and to minimise the effect of defects on the disc, the data of these sectors have error correction parity codes added and are interleaved in blocks of 16 sectors (an ECC block) before channel coding in accordance with the EFM+ (8 to 16 modulation) channel coding scheme of the DVD format and the channel coded data is stored onto a DVD in the form of pits and lands. When recording the data, ISO/UDF file system information (in accordance with ISO9660/UDF (Universal Disc Format)) is recorded on the disc to enable location of and therefore access to each sector of the disc. The final data recorded on a single layer DVD consists of a lead-in section, then the program data section, and then a lead-out section.

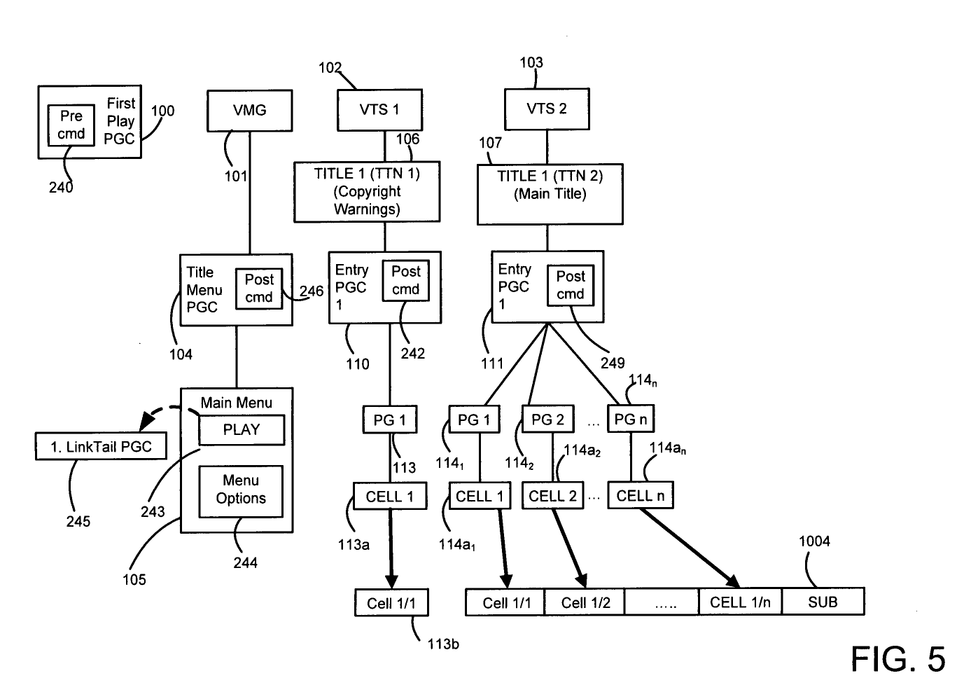

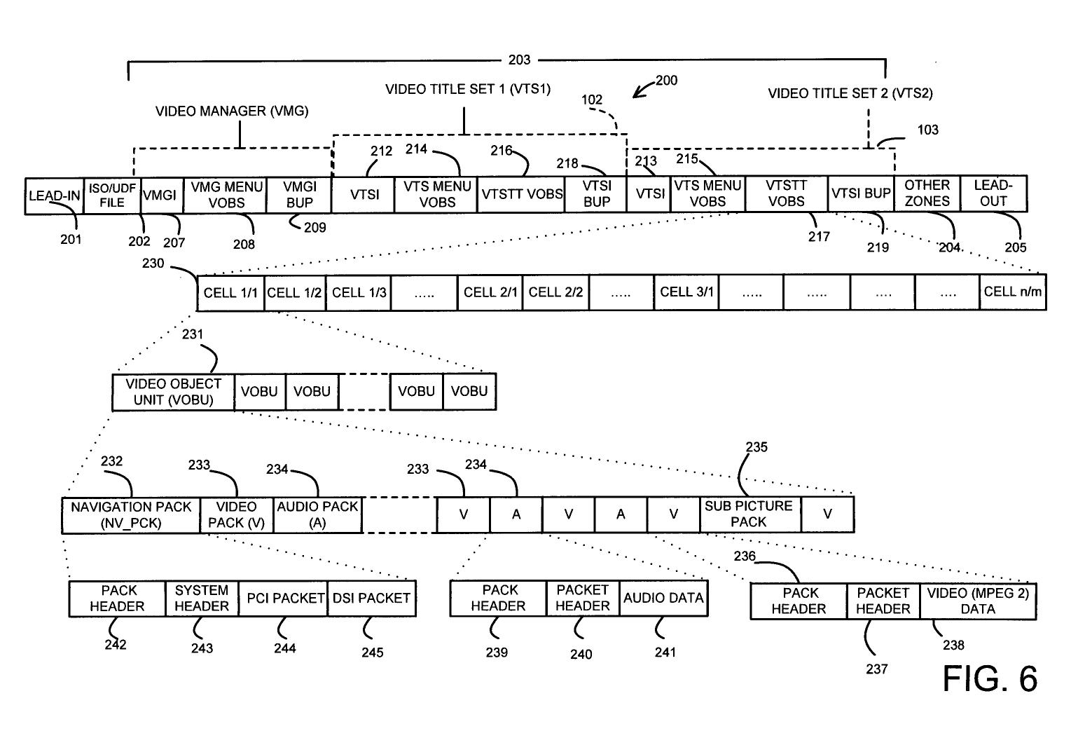

FIG. 5 shows a diagram for explaining, by way of an illustrative example, the presentation and navigation data structure of a DVD Video protected according to an embodiment of the present invention while FIG. 6 shows a diagram for illustrating the structure of a protected DVD Video zone.

As shown in FIG. 5, the navigation data structure comprises a first play program chain (PGC) 100 which is the first program chain to be executed when the disc is first inserted into a DVD player, a video manager (VMG) 101 and video title sets (VTSs).

The video manager 101 provides control information for the entire DVD video zone. In the example shown in FIG. 5, the video manager 101 has a title menu program chain 104 which, as shown, corresponds to the main menu 105. However, the DVD video zone need not necessarily have a title menu.

The number of video title sets will depend upon the particular DVD structure. FIG. 5 shows two video title sets, a first video title set VTS1 102 for introductory data such as copyright warnings and the like and a second video title set VTS2 103 for the main content of the DVD (which content may be a film (movie), music video, or the like).

Each video title set will usually have a language folder and one or more title folders. The language folder is associated with one or more menu program chains (PGCs) for providing menus to be displayed to the user to enable the user to select various options such as language, cut, aspect ratio (widescreen or not) and so on, while the title folder is associated with at least one title program chain (a title may contain up to 2¹⁵−1 program chains). For simplicity, FIG. 5 shows only the title folders. In the example illustrated, the first video title set VTS1 102 has a single title folder 106 (Title 1 (TTN 1)) for copyright warnings while the second video title set VTS2 103 has a single title folder 107 (Title 1 (TTN2)).

Each title folder 106 and 107 has at least one program chain (PGC). The first program chain in a title is known as the entry program chain (“entry PGC”). As shown in FIG. 5, each title folder has a single program chain 110 and 111 and these therefore form the entry PGCs.

Each program chain comprises program chain information (PGCI) comprising navigation data which controls access to components of a program chain and may typically contain from 0 to 99 programs (PG). A program chain may contain no programs but only PGCI. Such a program chain is known as a dummy program chain. For example, the first play program chain is a dummy program chain. The program chains may have pre-commands and post-commands that can be used to define the order in which the program chains are accessed by a player.

In the example shown in FIG. 5, a pre-command 240 of the first play PGC 100 causes a player to jump to the title 1 (TTN 1) title folder 106 and then to play the copyright warnings of the entry program chain 110 of first video title set 102. The entry program chain 110 has a post-command 242 to cause the player to jump to the title menu entry program chain 104 of the Video Manager and to display the main menu which in this example has a play button 243 and other menu options 244. A link tail PGC command 245 is provided to cause, in response to selection of the play button 243 by a user of the player, the player to exit the main menu and then execute a post command 246 of the title menu entry program chain 104 to cause the title TTN2 107 (which constitutes the main title in this example) to be played. The entry program chain 111 of the title TTN2 has a post command 249 to cause the player to return to the main menu after playing the title.

As an illustration, FIG. 5 shows the program chain 110 as having a single program (PG 1) 113 and the program chain 111 as having n programs (PG 1 to PG n) 114₁ to 114ₙ.

Each program has one logical cell or a sequence of logical cells that map to a corresponding physical cell or physical cells of the presentation data structure. In the example of FIG. 5, each program 113 and 114₁ to 114ₙ has a single logical cell 113a and 114a₁to 114aₙ. In the example shown, the logical cell 113a maps to a single physical cell 113b and each of the logical cells 114a₁ to 114aₙ maps to a corresponding physical cell. As will be discussed below, one or more physical cell or cells may, as shown in FIG. 5, provide a subversive region (“SUB”) 1004 before or as shown after the correct or true physical cells.

It will of course be appreciated that FIG. 5 is a much simplified example and that a DVD may contain more video title sets and that a video title set may contain many more titles, program chains, programs and cells than are shown in FIG. 5. Also the mapping between logical and physical cells need not be one to one and the physical cells may well be ordered differently from the logical cells.

FIG. 6 shows how a structure such as the one shown in FIG. 5 may be laid out on a DVD Volume 200. The DVD volume layout 200 has a lead-in 201 followed by ISO/UDF file system information 202, a DVD video zone 203, possibly one or more other zones 204, and finally a lead-out 205. The DVD video zone 203 has a video manager (VMG) 206 and one or more video title sets 102 and 103, as shown. The video manager (VMG) 206 consists of video manager information (VMGI) 207 comprising navigation data for the entire DVD video zone in a single file identified as VIDEO_TS.IFO, a video manager menu video object set (VMGM_VOBS) 208 provided as a single file identified as VIDEO_TS.VOB, and a back up file of the video manager information (VMGI_BUP) 209 in a single file VIDEO_TS.BUP. The video manager menu video object set 208 usually includes the presentation data for the title menu and any other non-dummy menu program chains.

Each video title set (VTS) consists of video title set information (VTSI) 212, 213 comprising navigation data to control the presentation of titles and menus in the video title set in a single file VTS_##_{—}0.IFO (where ## represents a two digit number between 01 and 99 representing the video title set number), a menu video object set 214, 215 for any video title set menu video objects (VTSM_VOBS) which typically contains the content for all types of menu within the video title set in a single file VTS_##_{—}0.VOB (as in the example shown in FIG. 5 there may be no menus within the video title set and so no VTS MENU VOBS), a video title object set (VTSTT_VOBS) 216, 217 for the video title set in one or more files identified as VTS_##_@.VOB (where @ is single digit number between 1 and 9) and a back up of the video title set information (VTSI_BUP) 218, 219 in a single file identified as VTS_##_{—}0.BUP.

Each video object set (VOBS) consists of a sequence of physical cells. For clarity in the diagram, FIG. 6 shows part of the physical cell set (CELL 1/1 to CELL n/m) only for the VTSTT_VOBS 217 of the video title set 2 (VTS2) 103. Each physical cell consists of one or more video object units (VOBUs) which each represent approximately 0.4 to one second of playback time (that is a number of consecutive frames). For simplicity in FIG. 6, the structure of only one physical cell 230 and one video object unit (VOBU) 231 of that physical cell 230 is shown.

As shown in FIG. 6, each video object unit consists of a navigation pack (NV_PCK) 232 followed by an integer number of video (V), audio (A) and sub-picture (S) packs 233, 234 and 235. On a DVD, each pack occupies one sector of user data on the disc (2048 bytes). Each video pack 233 consists of a pack header 236 identifying the pack followed by a packet header 237 identifying the packets within the pack and then the video data 238 in accordance with the DVD format, that is MPEG2 format. Similarly, each audio pack consists of a pack header 239 identifying the pack followed by a packet header 240 identifying the packets within the pack and the audio data 241 which may be in any format appropriate for DVD, for example MPEG, DTS, DD, LPCM, AC3.

Each navigation pack (NV_PCK) 232 consists of a pack header 242 identifying the pack, followed by a system header 243 and two navigation data packets 244 and 245. The first of the two packets 244 comprises presentation control information (PCI) for controlling button display and navigation and program presentation in real time and the second packet 245 comprises data search information (DSI) for controlling forward/reverse scanning and seamless branching. DVD players contain a track buffer to enable variable rate and seamless playback. There is therefore a time delay between reading by the read head and decoding and playing of the audio and video data. Therefore real time control information is distributed between and stored within the PCI and DSI packets and the player checks and utilises this information before and after the corresponding physical cell passes through the track buffer. Navigation packs 232 are thus used by the navigation engine or navigator 25 of the DVD player to ensure playback, trick play modes and search operations are executed successfully and in a timely manner.

It will be understood from the above that the DVD video zone thus includes navigation data that controls access and interactive playback and that navigation data exists at different levels within the DVD video zone. The navigation data includes control commands (for example for format, language, audio selection, sub-picture selection, parental management, display mode and display aspect), navigation commands (for example for general system parameters, system parameters, navigation timer and menu buttons), and search and user interface commands (for example for PGCI searches to enable selection of a particular menu or presentation data searches enable selection of a title, part of title (chapter), and so on). As will be explained below, the volume file system information also includes navigation and control data.

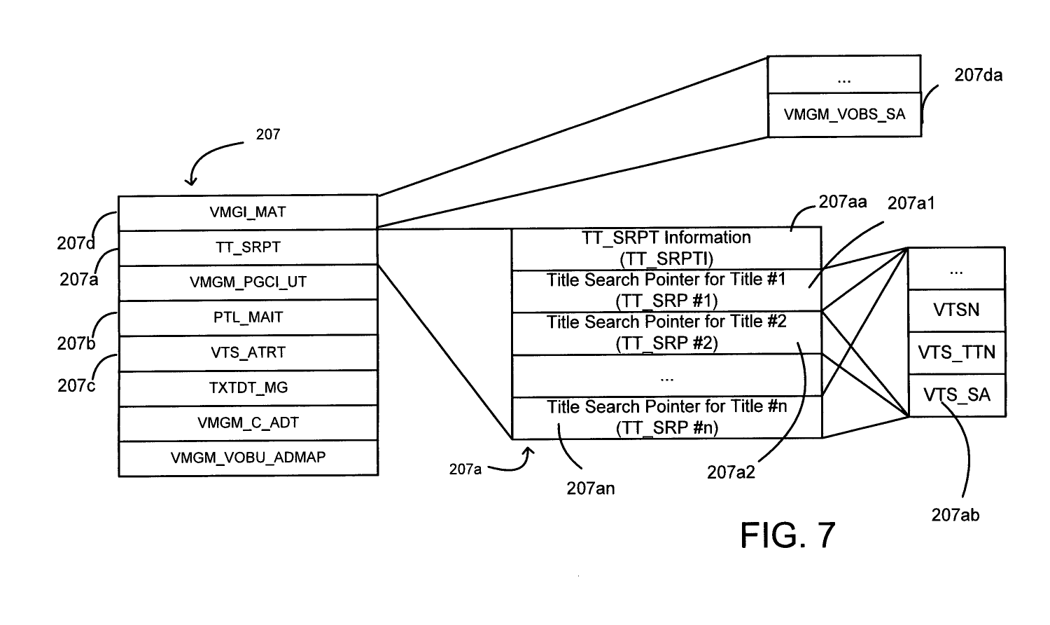

FIG. 7 shows the structure of the Video Manager Information (VMGI) 207 which comprises a Video Manager Information Management table (VMGI_MAT), navigation data such as, for example: the number and attributes of title sets; pointers to titles in a Title Search Pointer Table (TT_SPRT) 207a; a parental management information table (PTL_MAIT) 207b; attributes of the title menu (VMGM) video stream, audio stream and sub-pictures in a Video Title Set Attribute Table (VTS_ATRT) 207c; a VMGI_MAT table 207d and so on. The Title Search Pointer Table (TT_SPRT) 207a has Title Search Pointer Table information 207aa and a Title Search Pointer 207a1, 207a2 . . . 207an for each title (as an example titles #1, #2 . . . #n are shown). As shown in FIG. 7, the Title Search Pointers 207a1, 207a2 . . . 207an contain a pointer VTS_SA 207ab to the start address of the first and any subsequent VTS. The VMGI_MAT table 207d contains a pointer VMGM_VOBS_SA 207da to the start address of the video manager VOBS.

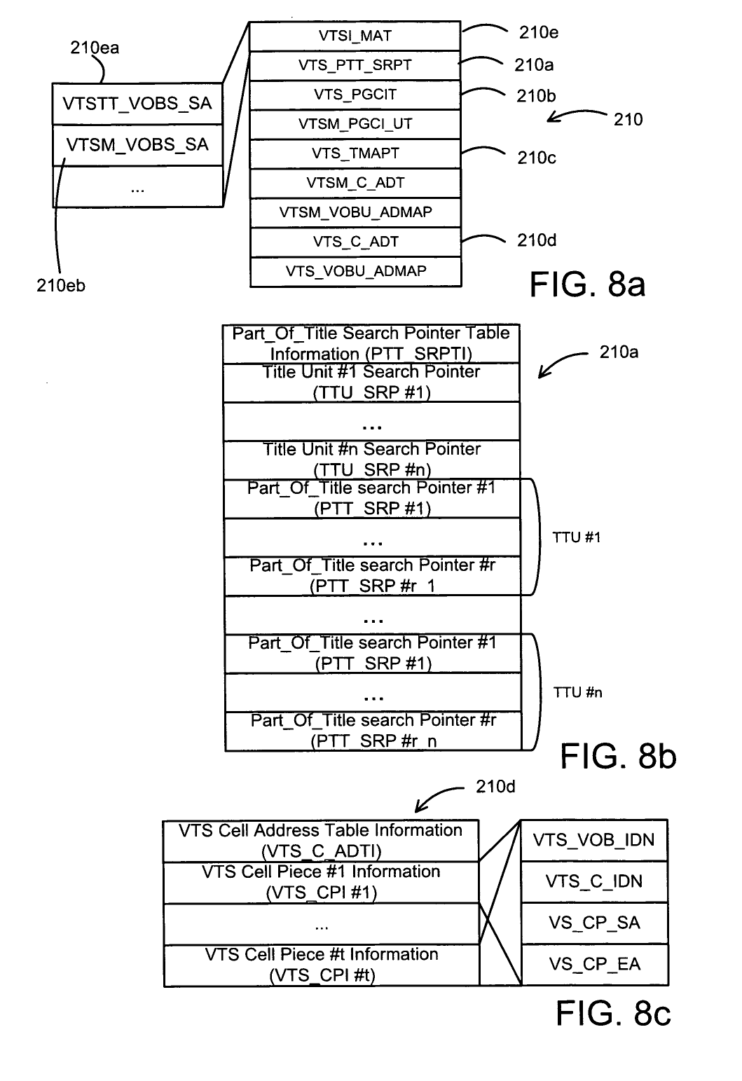

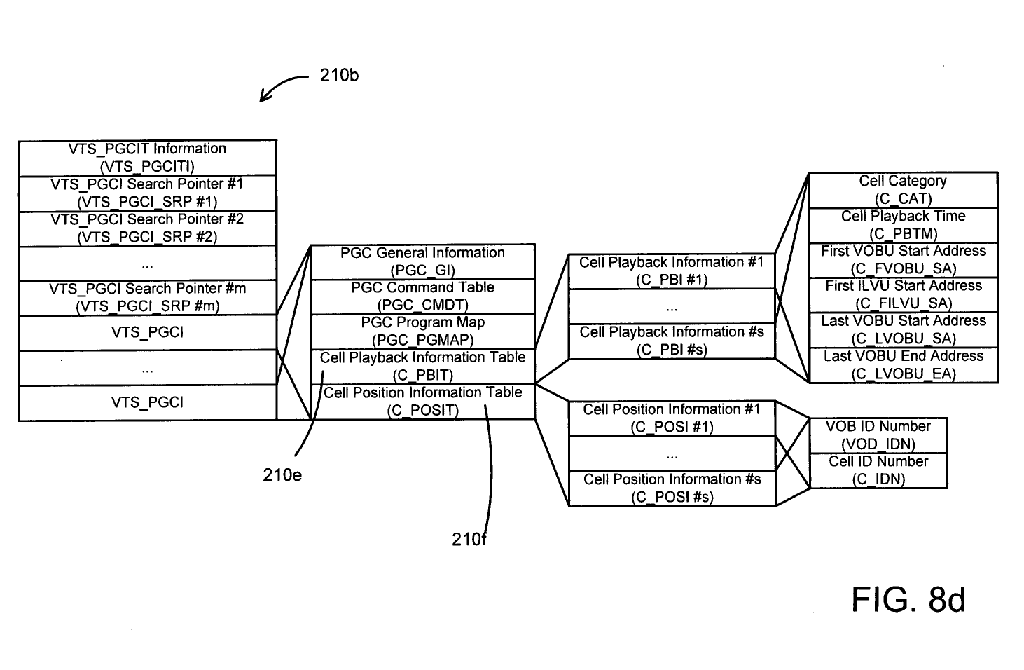

FIG. 8a show the structure of the Video Title Set Information (VTSI) 210 of a video title set which comprises navigation data such as, for example: pointers to chapters in a Video Title Set Part of Title Search Pointer Table (VTS_PTT_SRPT) 210a; pointers to program chains in a Video Title Set Program Chain Information Table (VTS_PGCIT) 210b; time maps in a Video Title Set Time Map Table (VTS_TMAPT) 210c; a Video Title Set Cell Address Table (VTS_C_ADT) 210d; a VTSI_MAT table 210e and so on. As shown in FIG. 8a, the VTSI_MAT 210e contains a pointer VTSM_VOBS_SA 210eb to the start address of the video title set menu VOBS and a pointer VTSTT_VOBS_SA 210ea to the start address of the video title set VOBS. The Video Title Set Part of Title Search Pointer Table (VTS_PTT_SRPT) 210a is shown in FIG. 8b and the Video Title Set Cell Address Table (VTS_C_ADT) 210d is shown in FIG. 8c. FIG. 8d shows the Video Title Set Program Chain Information Table (VTS_PGCIT) 210b which includes VTS program chain information (VTS_PGCI) which is associated with a program chain information including a cell playback information table (C_PBIT) 210e and a cell position information table (C_POSIT) 21.

In a program chain, the program chain information (PGCI) comprises navigation data such as, for example: the number of the programs within the chain; prohibited user operations; links between program chains; playback mode; pre-commands to be executed before accessing any of the programs of the chain; cell commands; and post-commands to be executed after accessing the programs of the chain.

In a video object unit, the presentation control information (PCI) comprises navigation data such as, for example: prohibited user operations, button information, non-seamless angle jump pointers, and presentation times while the data search information (DSI) comprises navigation data such as, for example: presentation times, audio gap lengths, VOBU pointers for forward and reverse scanning, video synchronisation pointers to audio and sub-picture packs reference picture pointers, link to next interleaved unit, and seamless angle jump pointers.

In a program chain, navigation commands can be included as discussed above as pre-commands to be executed before reading any cell(s) of the program chain and/or as post-commands to be executed after reading the cell(s) of the program chain. Examples of program chain navigation commands include “go to” instructions to go to a command number, “link to” instructions to program chain number, part of title number, cell number and so on, “jump” instructions to move out of the current domain or state of the DVD playback, and SPRM and GPRM setting and manipulating instructions and “comparison” instructions, so allowing conditional actions, for example allowing a “go to” or “jump” instruction to be executed in the event a certain comparison is true or a certain SPRM or GPRM parameter is set to a certain value.

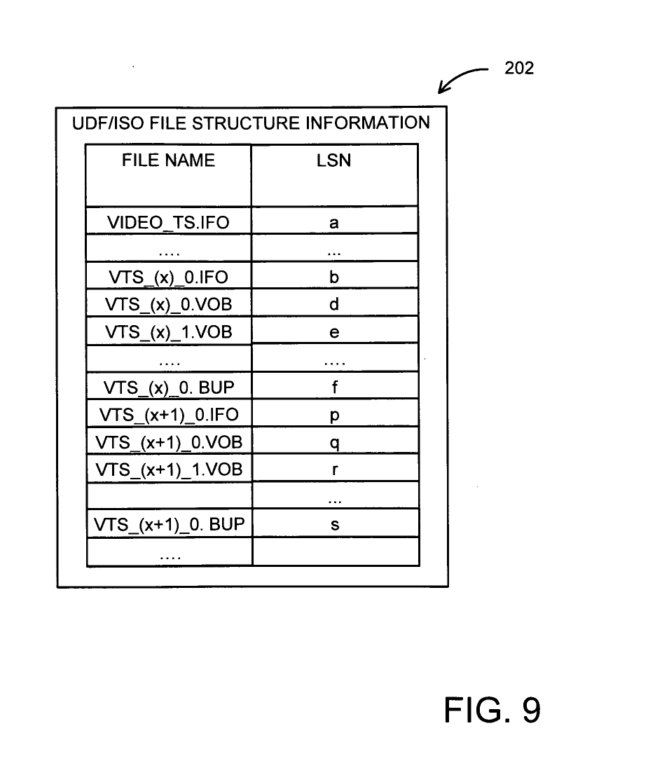

FIG. 9 shows a schematic view of some data contained in the UDF/ISO file system information. The form of the start address may depend on whether it is UDF or ISO file system, that is the start address may be given relative to a different location depending upon whether it is UDF or ISO file system. The UDF/ISO file system information 202 provides, as shown in FIG. 9, an address here given in the form of a logical sector number (LSN) for each file on the DVD to enable location of the files on the disc. It will be appreciated that the letters shown in FIG. 9 as given only as an illustration and do not necessarily represent actual logical sector numbers (LSN).

The explanation so far is a simplified overview of the DVD format of a DVD-Video protected according to an embodiment of the present invention. For a more detailed description of the DVD format and recording process, reference should be made to the DVD standards.

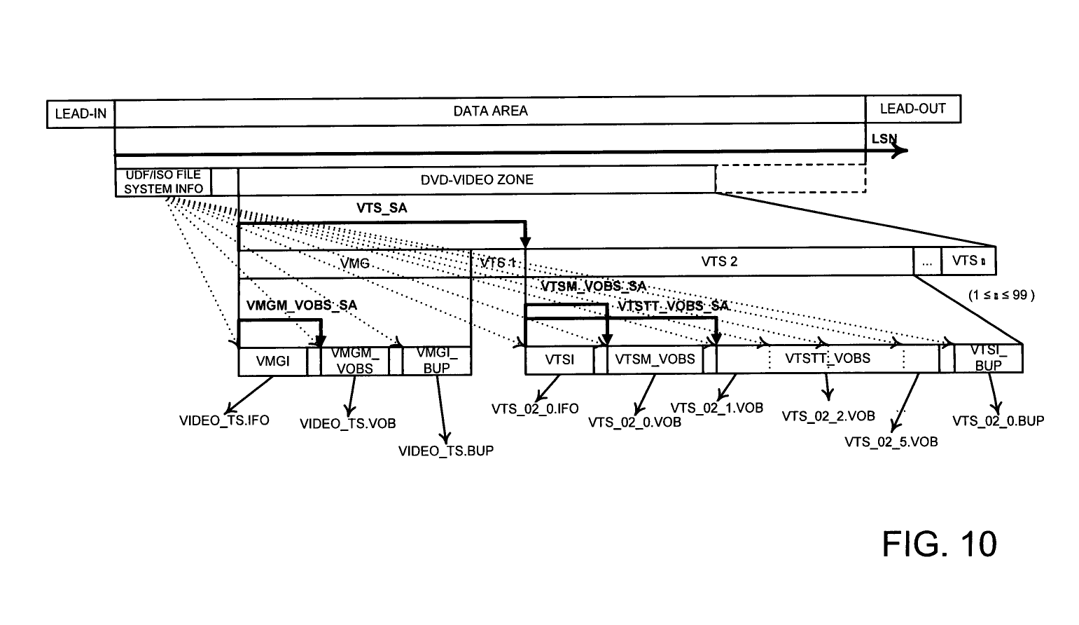

FIG. 10 shows a representation of part of a DVD-video to illustrate the fact that, as should be understood from the above and in particular from FIG. 9, the UDF/ISO file system information 202 contains pointers to the VMGI 207 file VIDEO_TS.IFO, the VMGM_VOBS 208 file VIDEO_TS.VOB, the VMGI_BUP 209 file VIDEO_TS.BUP, and, for each video title set, pointers to the corresponding VTSI file VTS_##_{—}0.IFO, any VTSM_VOBS file VTS_##_{—}0.VOB, each of the VTSTT_VOBS files VTS_##_@.VOB and the VTSI_BUP file VTS_##_{—}0.BUP. FIG. 10 also shows that the Video Manager VMGI contains (in the TT_SRP entries 207a1, 207a2 . . . 207an of the TT_SRPT 207aas shown in FIG. 7) a pointer VTS_SA to the start address of the first and any subsequent VTS and (in the VMGI_MAT 207d) a pointer VMGM_VOBS_SA to the start address of the video manager VOBS while the Video Title Set Information VTSI contains (in the VTSI_MAT as shown in FIG. 8a) a pointer VTSM_VOBS_SA to the start address of the video title set menu VOBS and a pointer VTSTT_VOBS_SA to the start address of the video title set VOBS.

The navigation information necessary in order to read a DVD-video may be accessed by locating the relevant files through the UDF/ISO file system (“file-based” approach) or by locating the Video Manager Information (VMGI) and then using the pointers in the navigation information contained in the VMGI and VTSI (“navigation-based” approach). The file-based approach is the approach generally used by unauthorised copying apparatus or rippers whilst most legitimate players will use the navigation-based approach.

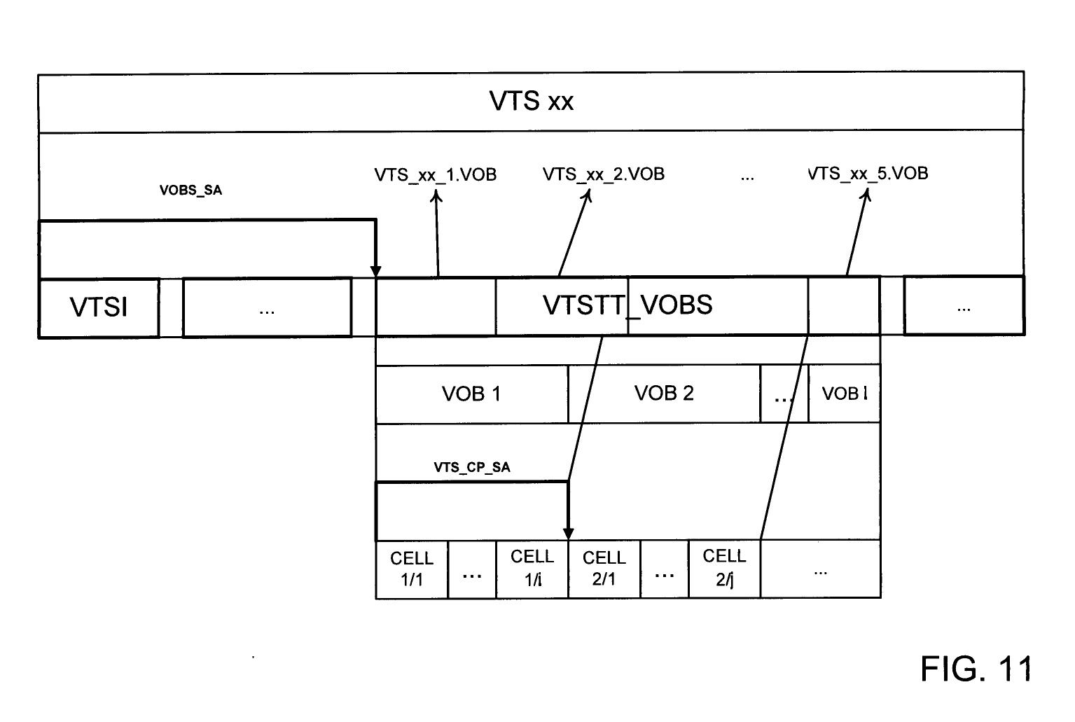

FIG. 11 shows a representation of one video title set of the part of a DVD-video shown in FIG. 10. The file boundaries within the VOB set are independent of the logical structure of the VOB set and bear no relationship with the logical boundaries within the VOB set. Accordingly, a file-based reader, whether authorised or not, has to determine the start of a VOB set by looking at the UDF/ISO information VOBS_SA for the first VOB file that is the VTS_xx_{—}1.VOB file in FIG. 11. However, for normal playback, it is expected that such a file-based player will, as shown in FIG. 11, once it has determined the start of a VOB set by looking at the UDF/ISO information, access individual cells in the VOB set by looking for example at the cell pointer data VTS_CP_SA information in the VTSI and so will not make use of the UDF/ISO information for subsequent VOB files (VTS_xx_{—}2.VOB . . . VTS_xx_{—}5.VOB, as shown in FIG. 11).

The copy protector 8 of the apparatus shown in FIG. 1 is configured to take advantage of the fact that it is expected that neither a navigation-based player nor a file-by-file based player will look at the UDF/IFO file after the location of the first VOB file has been determined. In particular, the copy protector 8 alters at least one of the start address information for a file in one or both of the UDF and ISO information and the size or length of the file in one or both of the UDF and ISO information. If the file start address is altered, a file-based ripper may be unable to locate the correct file and may be pointed to an incorrect location on the disc or may locate only part of the correct file because the start address may be part way through the file. If the file size is reduced from the actual file size and the start address is not altered, a file-based ripper may only locate part of the file. If the file size is increased from the actual file size and the start address is not altered, the ripper may additionally access an incorrect location on the disc in addition to that of the required file. Also, if the additional incorrect location size is significant, the resulting ripping time may be significantly increased. The data representing the file size increase need not necessarily have a cell structure, for example it may take the form of a gap. One or more physical cell or cells or data at such an incorrect location may contain scrambled or unreadable data. As another possibility or additionally, one or more physical cell or cells at such an incorrect location may contain subversive data that inhibits unauthorised copying or at least renders an unauthorised copy difficult to play or of very bad quality. For example, one or more physical cell or cells at such an incorrect location may, as shown in FIG. 5, provide a subversive region (“SUB”) 1004 that contains subversive data that detrimentally affects the production of and/or playability of an unauthorised copy. Such subversive cells will not form part of the navigational path of the DVD and so will not affect the ability of a legitimate player to play the DVD. As an example, such subversive data may subvert the reading capabilities of a drive attempting to read that area. Examples of subversive data that may be used are described in, for example WO02/11136, WO00/74053, WO01/61695 and WO01/61696, the whole contents of each of which are hereby incorporated by reference. Another possibility may be to inject non-correctable errors in the EFM+ bitstream or to deliberately damage areas of the glass master (and thus of the resultant DVDs) that do not form part of the navigation path in an attempt to make any copy DVD unplayable. These techniques may be used individually or in any combination.

Examples of ways in which the data processor 2, and the copy protector 2 in particular, may operate to alter at least one of the start address information for a file in one or both of the UDF and ISO information and the size or length of the file in one or both of the UDF and ISO information will now be described.

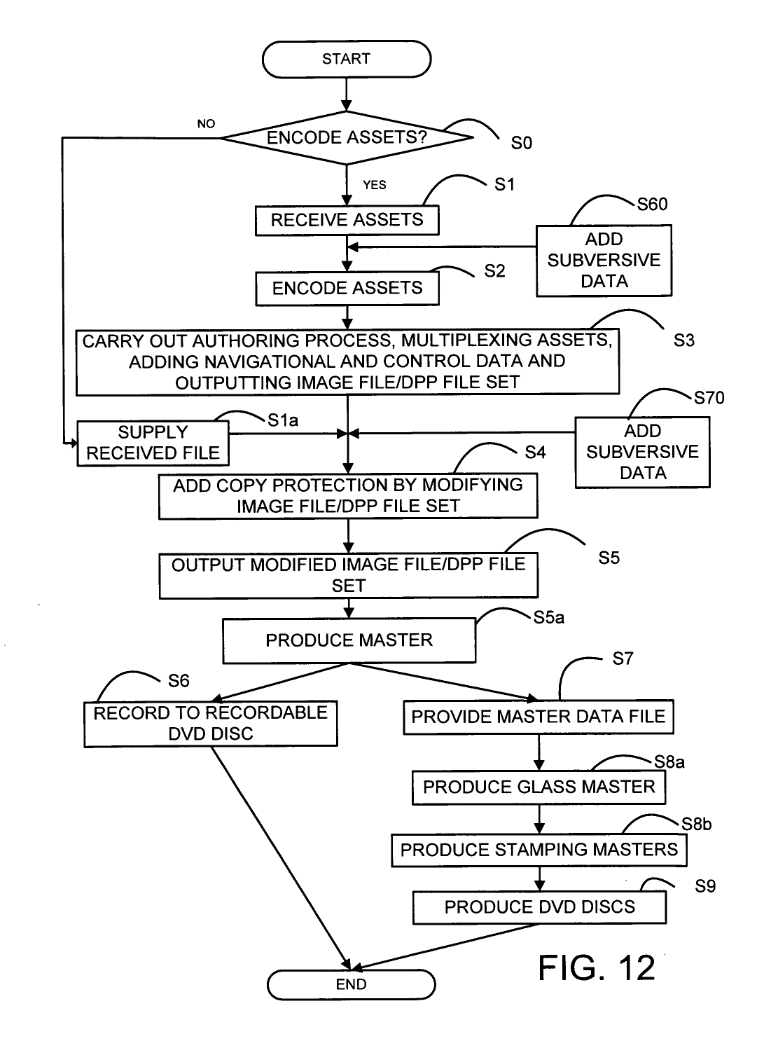

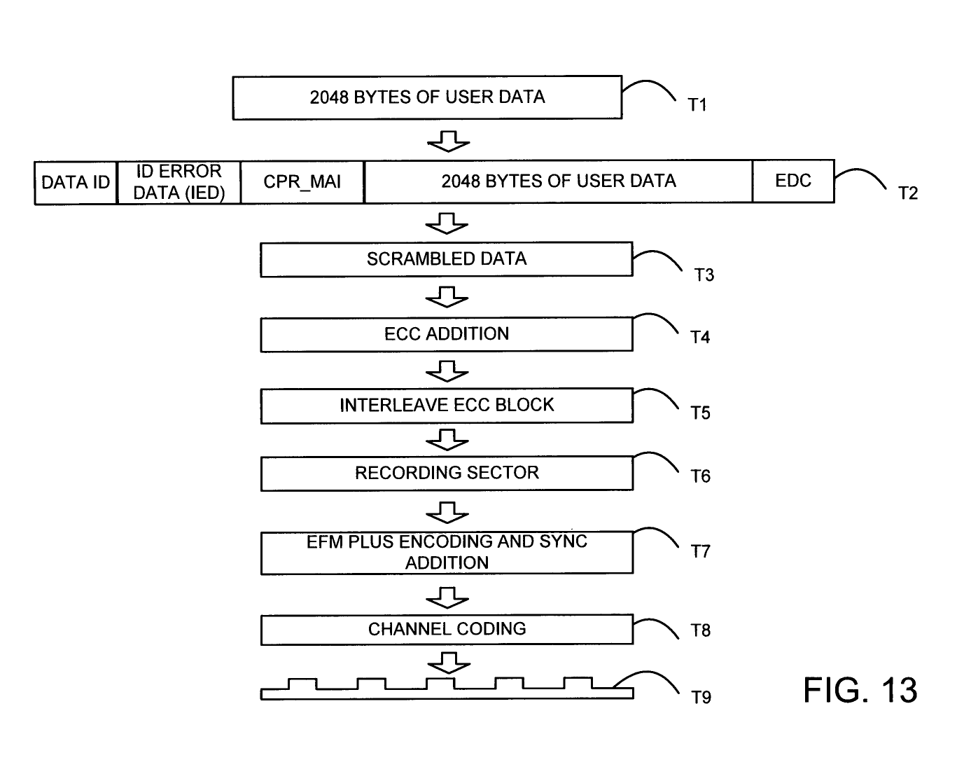

FIGS. 12 and 13 show a flow chart and a diagram, respectively, for explaining operations carried out by the apparatus shown in FIG. 1 during production of a DVD video zone.

Thus, when a user instructs the data processor 2 via the user interface 4 that a DVD video zone is to be produced, the controller 3 first determines, for example on the basis of user input, at SO whether assets are to be encoded or whether the file to be processed is an image file or DDP File Set received by the file receiver 91. If assets are to be encoded, then the controller 3 will generally prompt the user via the user interface 4 to provide the required assets which are then received by the asset receiver 5 at S1 in FIG. 10. The controller 3 may then prompt the user via the user interface 4 to check that the assets are in the correct data format (for example MPEG 2 for video) and, if not, to instruct the controller 3 to activate the asset encoder 6 to effect the necessary encoding at S2.

The controller 3 then at S3 in FIG. 10 controls the authorer 7, under user instructions via the user interface 4, to carry out an authoring process in which the user assembles the assets in the manner he or she desires with user-defined chapters and menus and a user-defined navigation path or paths through the content data and the authorer 7 multiplexes the user selected and organised assets and adds navigational and control data in compliance with the user's instructions and provides a image file or VIDEO_TS directory containing the VOB, IFO, BUP files to the copy protector 8 to produce an image file or DDP File Set.

If the answer at S0 is no, then at S1a, the controller 3 causes a received image file or DPP File Set to be supplied to the copy protector 8.

At S4, the copy protector 8 adds copy protection to the image file/DDP File Set. At S5, the copy protector outputs the modified image file or DDP File Set to the master producer 9. At S5a, the master producer 9 carries out a conventional mastering process, including the normal processes of encoding the copy-protected image file or DPP File Set in accordance with the appropriate DVD standard specification and so produces channel code data for recording as illustrated schematically by FIG. 13. Thus, the master producer 9 carries out, on each sector of user data (T1 in FIG. 13), processes such as scrambling, ECC (Error Correction Code) addition, interleaving and recording sector product code generation (T3, T4, T5 and T6 in FIG. 13), EFM plus encoding (T7 in FIG. 13) in accordance with the appropriate DVD standard specification and channel coding (T8 in FIG. 13) to provide an authored file (DPP File Set).

The master producer 9 produces a master file, for example a digital linear tape, containing the copy-protected authored file (DPP File Set) for supply via the master data file provider 10 to the replicator 11 which may be remotely located. As another possibility, the master file may be supplied to the replicator over a network which may be a local network or the Internet, for example. The replicator 11 produces a glass master carrying the image file and physical sector address tags mapping the logical sector numbers to the actual sectors on the glass master. This glass master is then used at to produce stamping masters from which the final DVD discs are produced (T9 in FIG. 13).

As another possibility or additionally, the master file may be supplied at S6 to the local recorder 12 which records the image file onto a writable DVD disc and adds physical sector address tags to the actual sectors on the optical disc.

Subversive data may, depending upon the type of subversive data, be added at S60 prior to encoding of the assets, or at S70 prior to the copy protection process, or at S4 as part of the copy protection process, depending upon the type of subversive data. As another possibility, subversive data may be provided by deliberately physically damaging a sector or sectors of the disc during the final recording process by the recorder 12 or during production of the glass master, for example.

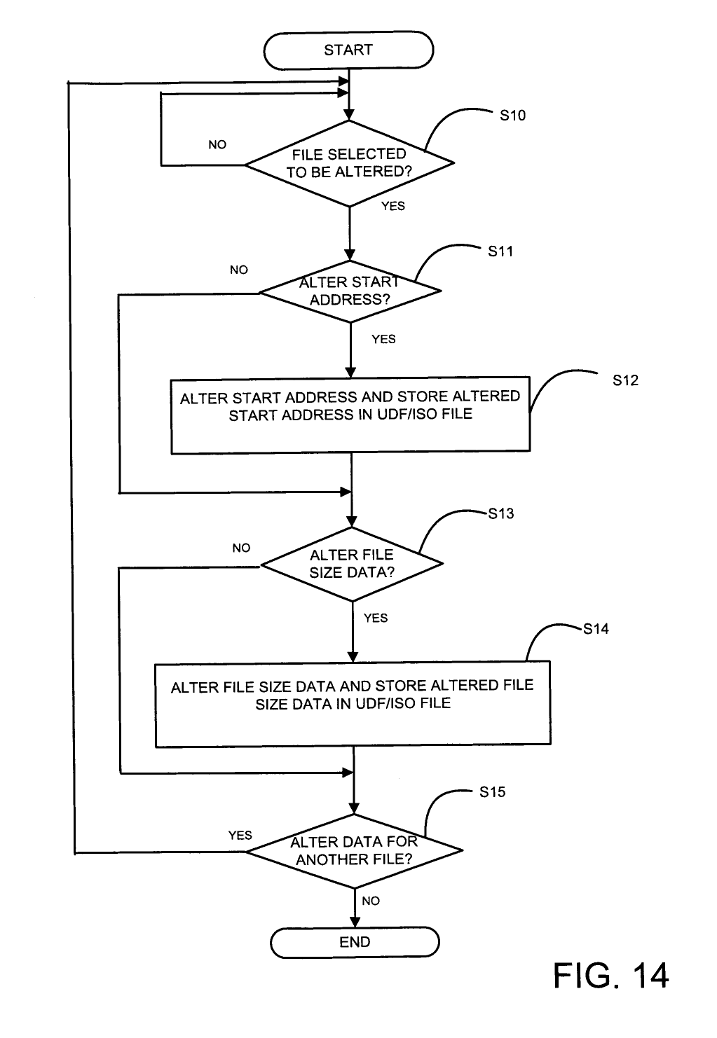

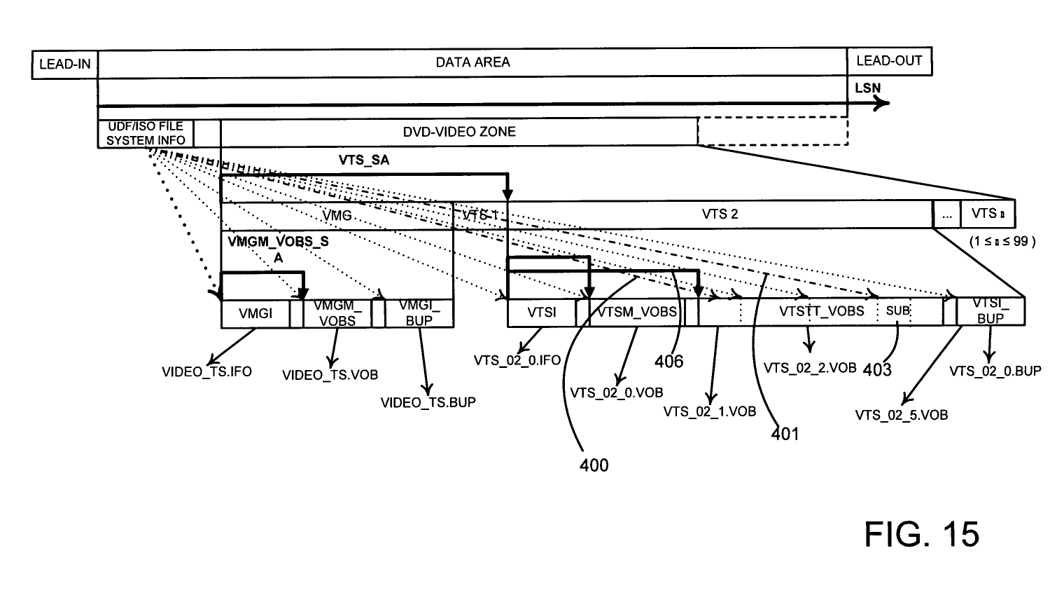

Examples of the operation of the copy protector 8 at S4 in FIG. 11 to alter file information in the UDF/ISO information but not in the Video Manager Information will now be described with the aid of FIGS. 14 and 15.

At S10 in FIG. 14, the copy protector determines whether a file has been selected to be altered. The selection of the particular file or files for which the start address is to be altered may be made by the copy protector in accordance with pre-stored instructions or in accordance with a routine implemented by the copy protector that selects files in a specific manner, for example at random or periodically or at predetermined intervals. As another possibility or additionally the selection may be made by the user using the user interface 4.

At S11 in FIG. 14, the copy protector determines whether the start address for the selected file is to be altered in the UDF or ISO information or both. The selection as to whether the start address is to be altered and whether this is to be in the UDF or ISO information or both may be made by the copy protector in accordance with pre-stored instructions or in accordance with a routine implemented by the copy protector that selects files in a specific manner, for example at random or periodically or at predetermined intervals. As another possibility or additionally the selection may be made by the user using the user interface 4.

If the answer at S11 is yes, the start address for the selected file is to be altered, then at S12 in FIG. 14, the copy protector alters the current start address and stores the altered start address in the UDF or ISO information or both, depending upon where the alteration is to be made. The alteration may change the start address to a predefined fixed address which represents a location of the DVD-video zone that is associated with subversive or unintelligible data or is otherwise unreadable or may simply be to the wrong file, to part way through the correct file or to a location outside the DVD-Video zone or to a location outside the volume.

At S13 in FIG. 14, the copy protector determines whether the file size for the selected file is to be altered in the UDF or ISO information or both. The selection as to whether the file size is to be altered and whether this is to be in the UDF or ISO information or both may be made by the copy protector in accordance with pre-stored instructions or in accordance with a routine implemented by the copy protector that selects files in a specific manner, for example at random or periodically or at predetermined intervals. As another possibility or additionally the selection may be made by the user using the user interface 4.

If the answer at S13 is yes, then at S14 in FIG. 14, the copy protector alters the file size data and stores the altered file size data in the UDF or ISO information or both, depending upon where the alteration is to be made. The alteration may be to reduce or increase the apparent file size. The amount of change in the apparent file size and whether the change is a reduction or an increase may be made by the copy protector in accordance with pre-stored instructions or in accordance with a routine implemented by the copy protector that selects the amount of change in the apparent file size and whether the change is a reduction or an increase in a specific manner, for example at random or periodically or at predetermined intervals. As another possibility or additionally this choice may be made by the user using the user interface 4.

At S15 in FIG. 14, the copy protector checks whether the data for another file is to be altered in the UDF/ISO information and, if so, repeats steps S10 to S15, until all the desired data alterations have been made.

FIG. 15 shows a modified version of FIG. 10 to illustrate the results of carrying out a method as described above with reference to FIG. 14. In the example shown in FIG. 15, the start address of VTS_{—}02_{—}1.VOB and the start address of VTS_{—}02_{—}5.VOB in the UDF/ISO information have both been altered. In this example, as shown by the dash-dot line 400, the start address of VTS_{—}02_{—}1.VOB in the UDF/ISO has been changed to point to a location part way through the file so that a ripper would not be able to access all of the data in the VOB file while, as shown by the dash-dot line 401, the start address of VTS_{—}02_{—}5.VOB in the UDF/ISO has been changed to point to a subversive data area (SUB) 403 at an address prior to the actual VTS_{—}02_{—}5.VOB file so that a ripper would access the subversive data file. The information in the VTSI is however still correct (as indicated by line 406 for VTS_{—}02_{—}1.VOB) and accordingly a player will still be able to navigate through the DVD video.

FIG. 14 shows the copy protector as being capable of altering the file start address and the file size for a number of files. As other possibilities, the copy protector may only be capable of altering the start address in which case the copy protector would not carry out steps S11, S14 and S15 or may only be capable of altering the file size data in which case the copy protector would not carry out steps S11, S12 and S14.

Where the copy protector alters the file start address in the UDF/ISO information, then, as mentioned above, the copy protector may alter the file start address so that, for example, the file start address points to a location on the DVD that stores a completely different file so that the ripper reads the correct files but in a scrambled or random order so that the content cannot be played correctly, to a location on the DVD part way through the correct file so that a ripper cannot not access all the content data of the file, or to a location outside the DVD-Video zone or to a location outside the volume, for example a location before the true file start location, that stores subversive data that causes a copy disc to be unreadable or unwatchable. The same or different approaches to changing the file start address may be used for different files.

Where the copy protector alters the apparent file size data in the UDF/ISO information, then, as mentioned above, the copy protector may reduce or increase the apparent file size data. The apparent file size data may be reduced (or increased) for all the files for which the data is to be changed or the file size data for some may be increased and the file size data for others reduced. Reducing the file size data will cause a file-by-file ripper to copy only part of the data for the file so that the ripper does not copy all of the content data and the resulting copy DVD will not be watchable. Increasing the file size data will cause a file-by-file ripper to copy subversive data added after the end of the file or to require a significant amount of extra time to rip the content from the copy protected DVD, even to the extent that, for example, the resulting copied content may not fit onto a DVD writable disc and may not be watchable.

The file for which the start address and/or file size data is altered in the UDF/ISO information may be a VOB file but it could be any file for which at least one of the start address and file size are listed in the UDF/ISO provided the necessary information can still be accessed by a legitimate player via the navigation information within the VMGI and VTSI.

As a consequence of the process carried out by the copy protector, the resulting DVDs have UDF/ISO information that is at least partially incorrect or inconsistent with the VMGI and/or the VTSI in terms of the start address and/or file size data for at least some of the files. When a copying apparatus or ripper attempts to copy such a DVD file-by file, it will identify the start address and file size data for the files that it is to copy from the UDF/ISO information and so will fail to access the correct content on the DVD. However, as the navigation data on the DVD has not been altered, that is the VMGI and the VTSI navigation data and any other navigation data is correct, a legitimate player accessing the DVD using a navigation approach, will have no difficulty in reading and playing the DVD because, as illustrated by FIG. 5, the legitimate player will be directed by the VMGI to the first play PGC 100 and thereafter will respond to a user's selection of displayed buttons and the navigation information in the VMGI and the VTSI and individual cells as the DVD is played. Preferably, the copy protector does not alter the UDF/ISO information for the first VOB (VTS_xx_{—}01.VOB) in the VTSTT_VOBS for each video title set on a DVD, so that a legitimate file-based player, such as a personal computer, that accesses the UDF/ISO information to locate the first VOB (VTS_xx_{—}01.VOB) but thereafter uses the VMGI and VTSI navigation data to navigate the DVD will not be adversely affected by the alteration of the start address and/or file size data of other files in the UDF/ISO information.

As mentioned above, the change to the file start address or file size data may cause a ripper to be directed to subversive data which inhibits the copying process or renders a copy DVD unreadable, unplayable or unwatchable. Examples of different types of subversive data are given above. As another possibility, the subversive data may simply be additional content data that will appear when the title is played and render the title unwatchable, for example such additional content data may be scrambled frames of title content data making the viewer believe that the DVD is faulty and/or notices alerting the viewer to the fact that the DVD is an unauthorised copy.

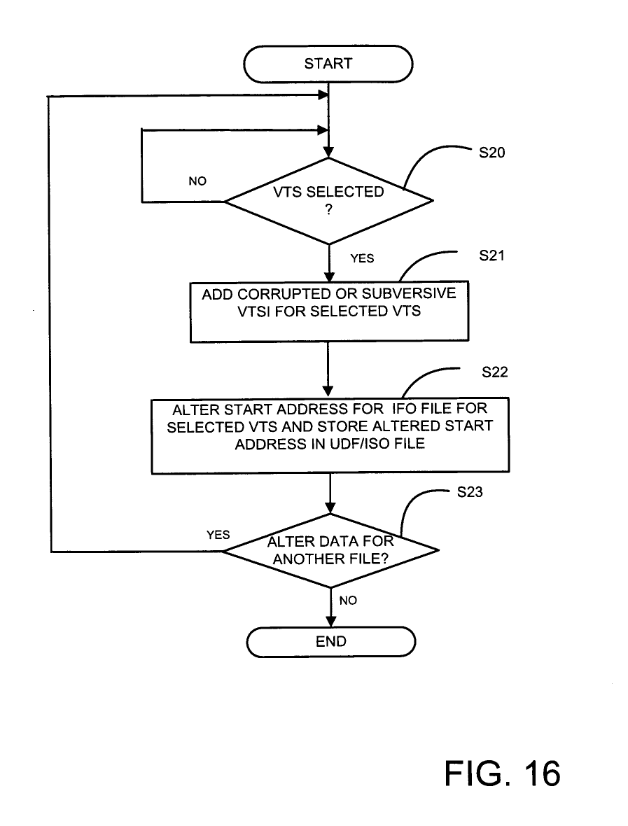

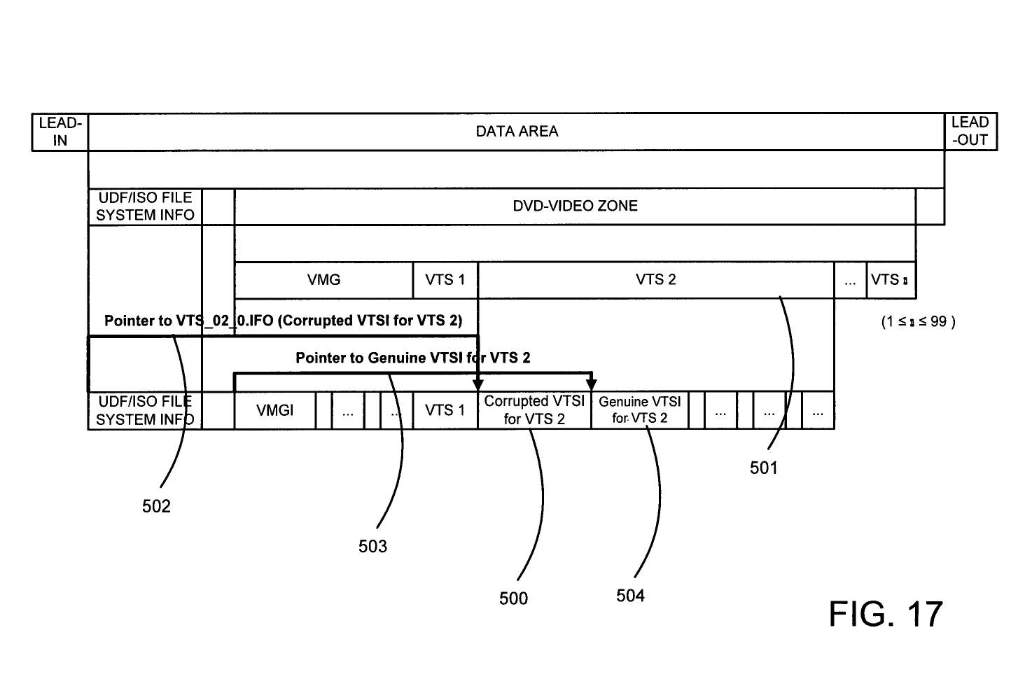

Another example of operation of the copy protector 8 at S4 in FIG. 11 to alter file information in the UDF/ISO information but not in the Video Manager Information will now be described with the aid of FIGS. 16 and 17.

In this example, at S20 in FIG. 16, the copy protector determines whether the VTS (or a selected VTS where the DVD video has more than one VTS) is to have the pointer or start address in the UDF/ISO information for its VTSI altered. If the answer at S20 is yes the, then at S21 in FIG. 16, the copy protector adds a subversive VTSI to the DVD video. Generally the copy protector will add the subversive VTSI immediately before or after the true VTSI to lessen the chances of a person operating the ripper suspecting that the VTSI pointer in the UDF/ISO information may have been altered. At S22 in FIG. 16, the copy protector changes the VTSI pointer in the UDF/ISO information so that it points to the subversive or corrupted VTSI instead of the correct VTSI and stores the start address of the subversive or corrupted VTSI in the UDF/ISO information in place of the correct VTSI start address. At S23 in FIG. 16, the copy protector checks whether the VTSI pointer data for another video title set (if the DVD video has more than one) is to be altered in the UDF/ISO information and, if so, repeats steps S20 to S23, until all the desired data alterations have been made.

FIG. 17 shows a representation of a DVD video which has been subject to the method described with reference to FIG. 16. Thus, as shown in FIG. 17, a corrupted VTSI 500 has been added for the video title set VTS2 501 and the pointer in the USF/ISO information altered to point (as shown by line 502 in FIG. 17) to the corrupted VTSI 500. However, the pointer in the VMGI still points (as shown by line 503 in FIG. 17) to the correct or genuine VTSI 504.

In the example illustrated by FIGS. 16 and 17, the copy protector alters the pointer or start address in the UDF/ISO information for the VTSI of a video title set so that a file-by-file ripper is directed towards a subversive or corrupted VTSI (VTSI 500 in FIG. 17) instead of the correct VTSI (VTSI 504 in FIG. 17) for that video title set but a legitimate player will locate the correct VTSI for that video title set by using the information in the VMGI. Also an IFO parsing ripper accessing the VTSI through the file system information will be affected as it will access a subversive or corrupted VTSI, resulting in a ripping process failure or in an unsatisfactory copy.

The copy protector may be capable of carrying out one or both of the methods described above with respect to FIGS. 14 and 16. Where the copy protector is capable of carrying out both methods, both or a selected one of these methods may be used for a single DVD video.

As described above, the data processor may be operable to alter at least one of the file length and the file start address for at least one of the content data files. As another possibility or additionally, the data processor may alter or corrupt error data so that it is incorrect, for example the Cyclic Redundancy Check (CRC) bytes for some files may be altered or corrupted within the file system information so as to render the file system information for those files seemingly incorrect and therefore unusable. Similarly any other information, such as the CRC length value or the checksum value, that would subvert the file system information access if it were incorrect may be altered or corrupted.

As shown in FIG. 1, the producing apparatus 1 has both authoring functionality (asset receiver 5, asset encoder 6 and authorer 7) and a file receiver 91. Where appropriate the apparatus may include only one of these, that is either the authoring functionality or the file receiver 91.

As mentioned above, the copy protector functionality may be provided within the authorer so that the copy protection does not form a separate step but is carried out as part of the authoring process.

In the above-described embodiments, the recording medium is a DVD or a precursor such as a glass master or stamping master. The recording medium may be another form of optical disc or a precursor. It will, of course, be appreciated that the present invention may be applied to other forms of digital recording media such as, for example, magnetic or magneto-optical recording discs. In addition, as described above, the recording medium is a disc that is read by spinning or rotating the disc about a central axis. It may, however, also be possible to apply the present invention to digital recording media in the form of Digital Linear Tape which is transported along a path past, rather than rotated with respect to, a read/write head.

What is claimed is:

1. Apparatus for providing recording data for a recording volume to be recorded onto a recording medium, the apparatus comprising a data processor operable:
to provide recording data having content data comprising a plurality of content data files and navigation data to enable a player of the recording medium to navigate through the content data, the recording data also having volume information comprising location data representing the location of the content data files within the recording volume; and
to cause data relating to file identification in the volume information for at least one of the content data files to be incorrect to inhibit a reader reading the volume information from finding the file or files.

2. Apparatus according to claim 1, wherein the data relating to file identification comprises a file start address and the data processor is operable to cause the file start address for at least one of the content data files to be incorrect.

3. Apparatus according to claim 1, wherein the data relating to file identification comprises a file length and the data processor is operable to cause the file length for at least one of the content data files to be incorrect.

4. Apparatus according to claim 1, wherein the data relating to file identification comprises a file start address and a file length and the data processor is operable to alter at least one of the file length and the file start address for at least one of the content data files.

5. Apparatus according to claim 1, wherein data relating to file identification information comprises data identifying incorrect or corrupt data.

6. Apparatus according to claim 1, wherein the data processor is operable to provide as the recording data at least one video title set having content data files comprising a video object data set, a video title set information file for the video title set and video manager information and comprising a volume file system information having data relating to file identification for enabling location of content data files and is operable to cause at least part of the data relating to file identification in the volume information for at least one of the content data files to be incorrect to inhibit a reader reading the volume information from finding the file or files.

7. Apparatus according to claim 6, wherein the data relating to file identification comprises a file start address and a file length for each content data file and the data processor is operable to alter at least one of the file length and the file start address for at least one of the content data files.

8. Apparatus according to claim 6, wherein the data processor is operable to add a corrupt video title set information file to the recording data for at least one video title set and the data relating to file identification comprises data identifying the corrupt video title set information file rather than the actual video title set information file for the at least one video title set.

9. Apparatus according to claim 6, wherein the volume information comprises at least one of UDF and ISO information.

10. Apparatus according to claim 6, wherein the data relating to file identification comprises error detection data and the data processor is operable to alter at least one of the error detection data.

11. A method of providing recording data to be recorded onto a recording medium, the method comprising:
providing recording data having content data comprising a plurality of content data files and navigation data to enable a player of the recording medium to navigate through the content data, the recording data also having volume information comprising location data representing the location of the content data files within the recording volume; and
causing data relating to file identification in the volume information for at least one of the content data files to be incorrect to inhibit a reader reading the volume information from finding the file or files.

12. A method according to claim 11, wherein causing data relating to file identification in the volume information for at least one of the content data files to be incorrect comprises altering the identification information.

13. A method according to claim 11, wherein causing data relating to file identification in the volume information for at least one of the content data files to be incorrect comprises causing at least one of a file start address and a file length for at least one of the content data files to be incorrect.

14. A method according to claim 11, wherein providing the recording data comprises providing at least one video title set having content data files comprising a video object data set, video title set information file for the video title set, video manager information.

15. A method according to claim 14, wherein the volume information comprises at least one of UDF and ISO information.

16. A method according to claim 14, wherein causing data relating to file identification in the volume information for at least one of the content data files to be incorrect comprises altering at least one: of file length data of at least one of the content data file; file start address data of at least one of the content data file; error detection data of at least one of the content data file.

17. A method according to claim 14, wherein causing data relating to file identification in the volume information for at least one of the content data files to be incorrect comprises adding a corrupt video title set information file to the recording data for at least one video title set and causing the data relating to file identification to identify the corrupt video title set information file rather than the actual video title set information file for the at least one video title set.

18. A method according to claim 14, wherein causing data relating to file identification in the volume information for at least one of the content data files to be incorrect comprises altering at least one of the file length and the file start address for at least one of the content data files and adding a corrupt video title set information file to the recording data for at least one video title set and causing the identification information to identify the corrupt video title set information file rather than the actual video title set information file for the at least one video title set.

19. A method according to claim 14, further comprising at least one of: providing a recording data file comprising the recording data; producing a master carrying the recording data; producing a precursor to a master carrying the recording data; producing at least one recorded medium such as an optical disc, for example a DVD carrying the recording data; and writing the recording data onto a writable or rewritable optical disc, for example a DVD.

20. A computer storage medium storing program to program a processor:
to receive recording data having content data comprising a plurality of content data files and navigation data to enable a player of the recording medium to navigate through the content data, the recording data also having volume information comprising location data representing the location of the content data files within the recording volume; and
to cause data relating to file identification in the volume information for at least one of the content data files to be incorrect to inhibit a reader reading the volume information from finding the file or files.
